(19) United States
(12) Patent Application Publication
(10) Pub. No.: US 2020/0272991 A1
(43) Pub. Date: Aug. 27, 2020

(54) INTELLIGENT DYNAMIC CONTAINER ROUTING

(71) Applicant: Inlecom Systems Limited, London (GB)

(72) Inventors: PANAYOTIS KATSOULAKOS, W Sussex (GB); GERASIMOS KOULOUMPIS, London (GB); VASSILEIOS KARAKOSTAS, Macclesfield (GB); PATRICK J. O'SULLIVAN, Dublin (IE)

(21) Appl. No.: 16/285,650

(22) Filed: Feb. 26, 2019

(51) Int. Cl. G06Q 10/08; G06Q 10/06; H04W 4/029; G06F 17/18

(52) U.S. Cl. CPC G06Q 10/08355; G06F 17/18; H04W 4/029; G06Q 10/06315

(57) ABSTRACT

An intelligent dynamic container routing method interrogating by a digital hub in a primary way station on a route from an origin to a final destination, a computing appliance disposed on a shipping container containing an item, identifying from the interrogation the final destination and conditions upon which the item is to be shipped to the final destination, and broadcasting a request containing an identification of the final destination and the conditions to one or more other digital hubs positioned in correspondingly different way stations and communicatively linked to the interrogating digital hub. Then, an indication is received from each of the other digital hubs indicating if the container is able to be transported to the final destination without violating the conditions. Finally, one of the way stations is selected as a next destination for the shipping container and a record written to the computing compliance indicating as much.

### BACKGROUND OF THE INVENTION

### Field of the Invention

The present invention relates to the field of container transport in a supply chain and more particularly to dynamically routing a container within the supply chain.

### Description of the Related Art

A supply chain is a network between a company and its suppliers to produce and distribute a specific product, and the supply chain represents the steps it takes to get the product or service to the customer. Supply chain management is a crucial process because an optimized supply chain results in lower costs and a faster production cycle. Business logistics management refers to the production and distribution process within the company, while supply chain management includes suppliers, manufacturers, logistics and transportation companies and retailers that distribute the product to the end customer. Supply chains include every business that comes in contact with a particular product, including companies that assemble and deliver parts to the manufacturer.

Because the traditional supply chain involves many different actors utilizing many different disparate information systems, information sharing amongst the different actors can be challenging. Transparency into the state of affairs of a given transaction depends largely upon the willingness and diligence of each actor in the supply chain of the transaction to provide accurate and timely information to one another. In a single transaction, so much seems not so daunting, but in a supply chain ecosystem of hundreds if not thousands of transactions are ongoing at any given time and much of the resources available within the ecosystem—particularly in respect to transportation and logistics—remain dependent upon the state of multiple different transactions.

A supply chain information sharing system aims to provide some transparency into the state of affairs of different transactions in a corresponding supply chain. As part of the transparency, the supply chain information system ingests data from different actors in the supply chain, processes the ingested data in order to produce a result reflective of a state of the supply chain, and exposes the produced result to one or more of the actors. In a supply chain spanning a single jurisdiction amongst only a handful of actors, so much is not of tremendous consequence, but in a supply chain that spans different jurisdictional boundaries and involves many different actors with different policies regarding the privacy of data, maintaining both transparency of transactions in the supply chain while not running afoul of the data privacy policies of both the private actors in the supply chain and the public governmental interests in which the actors reside can be challenging.

### BRIEF SUMMARY OF THE INVENTION

Embodiments of the present invention address deficiencies of the art in respect to package routing in a supply chain and provide a novel and non-obvious method, system and computer program product for intelligent dynamic package routing. In an embodiment of the invention, an intelligent dynamic container routing method includes electronically and wirelessly interrogating by a digital hub in a primary way station on a route from an origin to a final destination, a computing appliance disposed on a shipping container containing an item. Then, the final destination and one or more conditions upon which the item is to be shipped to the final destination is identified from the interrogation. A request is broadcast containing an identification of the final destination and the conditions to one or more other digital hubs positioned in correspondingly different way stations and communicatively linked to the interrogating digital hub over a computer communications network. In response, an indication is received from each of the other digital hubs of whether or not the shipping container is able to be transported to the final destination through an associated one of the correspondingly different way stations without violating any of the conditions. Finally, one of the different way stations is selected as a next destination for the shipping container and a record written to the computing compliance of the shipping container indicating the selected one of the different way stations.

In one aspect of the embodiment, each response from an associated one of the correspondingly different way stations includes a contemporaneous weather condition at the associated one of the correspondingly different way stations, so that the selected one of the different way stations is selected according to a corresponding response indicating a favorable weather condition, such as a temperature condition within a specified range.

In another aspect of the embodiment, the method additionally includes assigning a score to each of the different way stations based upon at least one criteria. Then, each assigned score may be weighted. For instance, the score may be weighted according to availability of a specified mode of transport at an associated one of the correspondingly different way stations. As another example, the score may be weighted according to a degree of energy utilization associated with an associated one of the correspondingly different way stations. As yet another example the score may be weighted according to a cost of routing through an associated one of the correspondingly different way stations. In any case, one of the associated one of the correspondingly different way stations may be selected as a next destination for the shipping container that has the highest weighted score.

In yet another aspect of the embodiment, the one or more terms are set forth in a service level agreement (SLA) for delivery of the item. As such, a score may be assigned to each of the different way stations based upon at least one criteria and the assigned score compared to at least one term in the SLA. Finally, one of the associated one of the correspondingly different way stations may be selected as a next destination for the shipping container that has the highest weighted score but that has an assigned score meeting the at least one term of the SLA. However, on condition that the selected one of the associated one of the correspondingly different way stations that has the highest weighted score has an assigned score that fails to meet the at least one term of the SLA, a prompt may be generated in a display of the primary way station to change the at least one term of the SLA so that the assigned score meets the at least one term of the SLA.

In another embodiment of the invention, an intelligent dynamic container routing method, includes receiving in a recipient digital hub in a corresponding way station disposed on a route from an origin to a final destination, a broadcast request from a broadcasting digital hub in a corresponding way station disposed upstream from the way station of the recipient digital hub on the route, the broadcast request encapsulating an identification of the final destination and one or more conditions upon which an item is to be shipped to the final destination. Then, it is determined whether or not the way station of the recipient digital hub is disposed at the final destination. On the condition that it is determined that the way station of the recipient digital hub is disposed at the final destination, a response is transmitted to the broadcasting digital hub including an indication that the item is able to be transported to the final destination without violating any of the conditions. On the other hand, on the condition that it is determined that the way station of the recipient digital hub is not disposed at the final destination, the request is re-broadcast to a downstream way station on the route, a response received from the downstream way station, and the received response transmitted to the broadcasting digital hub.

In one aspect of the embodiment, the method further includes determining whether the way station of the recipient digital hub is able to meet the one or more conditions and on condition that the way station of the recipient digital hub is unable to meet the one or more conditions, inserting into the response before transmitting, a notification of rejection. In another aspect of the embodiment, the method additionally includes retrieving from cached storage in the recipient digital hub, one or more capabilities of one or more way stations downstream from the way station of the recipient digital hub, determining from the capabilities in the cached storage whether the one or more way stations downstream are able to meet the one or more conditions, and on condition that the one or more way stations downstream from the way station of the recipient digital hub are unable to meet the one or more conditions, identifying from the request, a network address of a digital hub of an originating waypoint on the route, inserting into the response before transmitting, a notification of rejection and transmitting the response to the network address. In yet another aspect of the embodiment, the method additionally includes extracting from the response, an integer value of a number of way stations from a way station disposed at the final destination, incrementing the integer value, and inserting into the response before transmitting, the incremented integer value.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for intelligent dynamic package routing;

FIG. 2 is a schematic illustration of a data processing system configured for intelligent dynamic package routing; and,

FIG. 3 is a flow chart illustrating a process for intelligent dynamic package routing.

### DETAILED DESCRIPTION OF THE INVENTION

Embodiments of the invention provide for intelligent dynamic package routing. In accordance with an embodiment of the invention, a computing appliance disposed on a shipping container containing an item may be interrogated to determine both an origin and a destination to which the item is to be delivered along with conditions which must be fulfilled in the delivery of the item to the destination. A request may then be formulated encapsulating the origin, destination and conditions, and forwarded by broadcast message to one or more communicatively linked digital hubs, each associated with a different way station en route to the destination. In response to the broadcast request, an indication may be received from each of the hubs indicating whether or not the shipping container is able to be transported to the final destination through an associated one of the correspondingly different way stations without violating any of the conditions. Based upon the received responses, one of the different way stations is then selected as a next destination for the shipping container and a record may be written to the computing compliance of the shipping container indicating the selected way station.

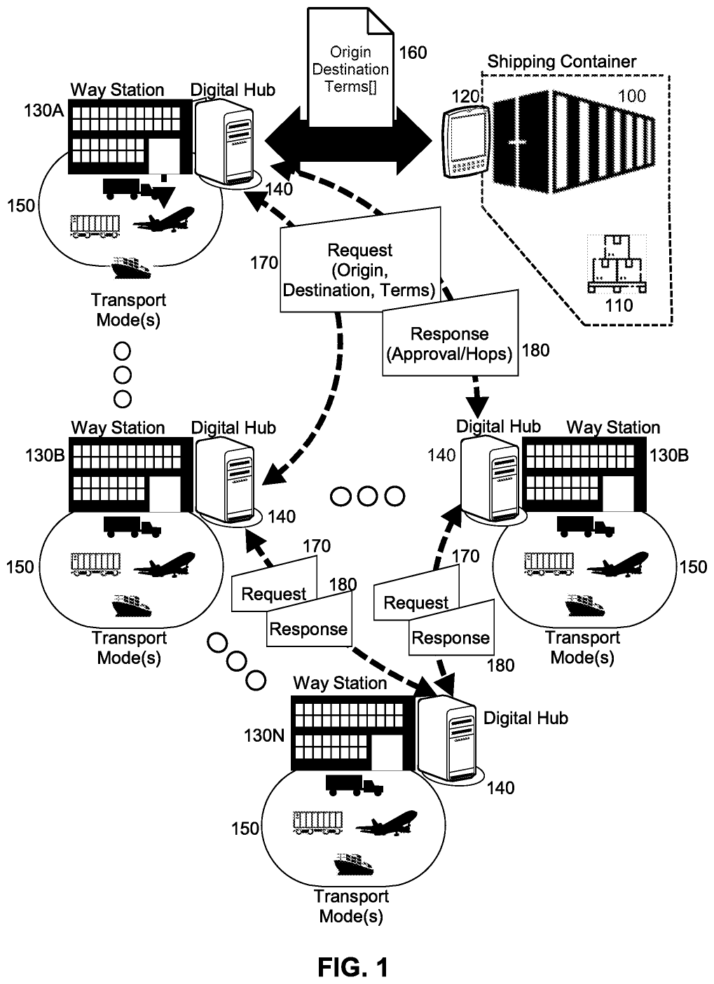

In further illustration, FIG. 1 pictorially shows a process for intelligent dynamic package routing. As shown in FIG. 1, different way stations 130A, 130B, 130N are provided and include an associated digital hub 140, and are associated with one or more prospective modes of transport 150, such as rail, truck, ship and airplane such that containers received in a corresponding one of the different way stations 130A, 130B, 130N may be received in one of the modes of transport 150 and forwarded to a next one of the different way stations 130A, 130B, 130N by a same or different one of the modes of transport 150. As such, different combinations of the way stations 130A, 130B, 130N in different sequences define different routes from an origin way station 130A to a destination way station 130N by way of one or more intermediate way stations 130B.

A shipping container 100 containing an item or pallet of items 110 is received in the origin way station 130A. The digital hub 140 at the origin way station 130A interrogates a computing appliance 120 affixed to the shipping container 100 to discover the content of the shipping container 100 including the item or pallet of items 110 and to receive an indication of a destination way stations 130N of the item or pallet of items 110 and also one or more conditions required for the delivery of the item or pallet of items 110 to the destination way station 130N. Thereafter, a request 170 is generated to include an indication of both the origin way station 130A and the destination way station 130N, and also the conditions for delivery of the item or pallet of items 110 to the destination way station 130N.

The request 170 is then broadcast to one or more other digital hubs 140 positioned in correspondingly different way stations 130B and communicatively linked to the interrogating digital hub 140 over a computer communications network. As each of the digital hubs 140 in the different way stations 130B receives the broadcast request 170, each of the digital hubs 130 in the different way stations 130B determines whether or not the conditions of the request 170 can be met by a corresponding one of the way stations 130B, including whether or a mode of transport 150 supported by the corresponding one of the way stations 130B is permitted by the conditions of the request 170 and whether or not the corresponding one of the way stations 130B is part of a route to the destination way station 130N. Other conditions include whether or not an allocated fee in the conditions for routing the item or pallet of items 110 is acceptable at the corresponding one of the way stations 130B, and whether or not physical environment including temperature and humidity of the corresponding one of the way stations 130B is within a permissible range defined by the conditions.

In the event that the digital hub 140 of the way station 130B determines that the conditions of the request 170 cannot be met, a response 180 rejecting the request 170 can be returned upstream to the origin way station 130A. However, to the extent that the digital hub 140 of the way station 130B determines that the conditions of the request 170 can be met, the request can be forwarded to a next way station 130B en route to the destination way station 130N and the process can repeat until digital hubs 140 of all corresponding way stations 130B en route to the destination way station 130N including the digital hub 140 at the destination way station 130N determine that the conditions of the request 170 can be met. In that instance, the digital hub 140 at the destination way station 130N returns a response 180 to the origin way station 130A, either directly, or by return path through each of the intermediate way stations 130B, the response indicating a number of way stations 130B, 130N required to form the route from the origin way station 130A to the destination way station 130N.

Upon receipt of each response 180, the digital hub 140 at the origin way station 130A may select one of the different way stations 130B as a next destination for the shipping container 100 with the item or pallet of items 110. The selection can be based, for instance, on a shortest number of way stations 130B, 130N between the origin way station 130A and destination way station 130N, or a predominance of a particular mode of transport 150 supported at each way station 130B en route to the destination way station 130N, or contemporaneous environmental conditions at one or more of the way stations 130B en route to the destination way station 130N such as an absence of precipitation, storm weather, freezing conditions or overly hot or humid weather. Finally, the digital hub 140 at the origin way station 130A writes a record to the computing compliance 120 of the shipping container 100 indicating the selected one of the different way stations 130B to which the container 100 is to be transported next such that upon receipt of the container 100 at the selected way station 130B, the process can repeat once again until the container 100 arrives at the destination way station 130N.

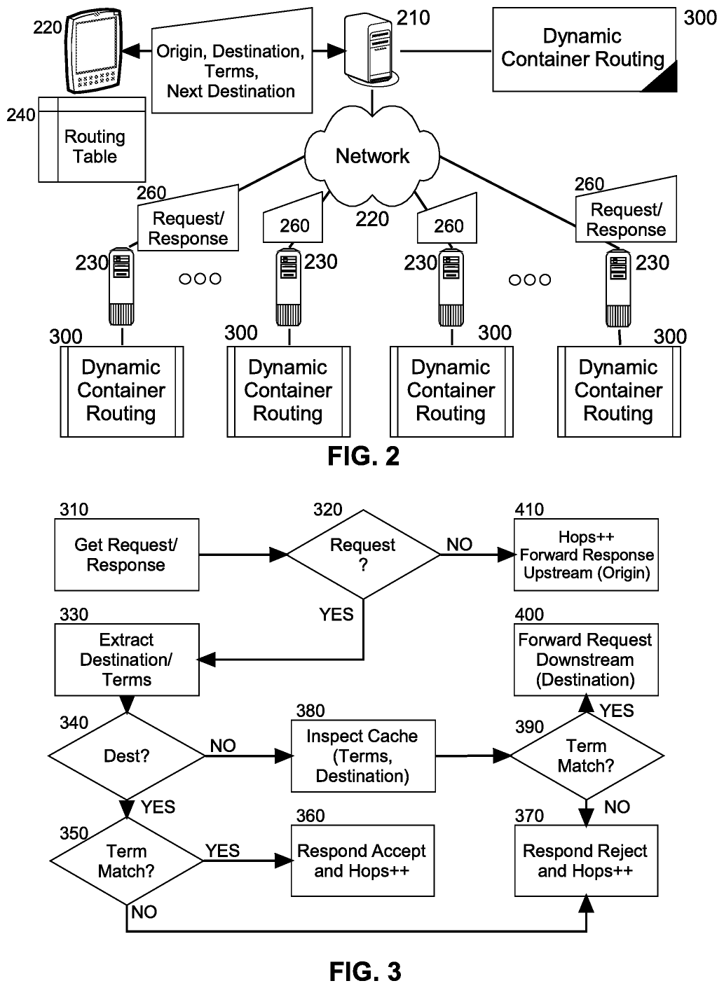

The process described in connection with FIG. 1, may be implemented within a data processing system. In yet further illustration, FIG. 2 schematically shows a data processing system configured for intelligent dynamic package routing. The system includes a host computing platform that includes one or more computers, each with memory and at least one processor. The host computing platform 210 supports the operation of a dynamic container routing module 300. As well, the host computing platform 210 is communicatively coupled to different remote server computers 230, each supporting a corresponding dynamic container routing module 300. Finally, the host computing platform 210 has a wireless communicative linkage to a computing appliance 220 affixed to a shipping container, the computing appliance having a routing table 240 indicating a route assigned to the shipping container from origin way station to destination way station.

Each dynamic container routing module 300 includes computer program instructions operable upon execution in memory of a corresponding computer, to interrogate the computing appliance 220 in order to discover an origin way station, a destination way station, a next assigned way station en route to the destination way station, and one or more conditions upon which the shipping container is to be transported to the destination way station. The computer program instructions further are operable to generate a request for broadcast transmission to different communicatively accessible way stations, requesting transport of the shipping container to the destination way station according to the conditions upon which the shipping container is to be transported to the destination way station. The computer program instructions yet further are operable to receive a response from each of the different communicatively accessible way stations, the response indicating whether or not a corresponding one of the different communicatively accessible way stations is able to route the shipping container to the destination way station without violating any of the conditions, and also a number of way stations through which the shipping container must pass to reach the destination way station.

Finally, the computer program instructions are enabled to select as a next way station for the shipping container, one of the different communicatively accessible way stations and to write into the routing table 240 of the computing appliance 220, the selected next way station. In this regard, the computer program instructions may assign a score to each of the different way stations based upon at least one criteria, and each assigned score is then weighted according to a transport factor. The weighting, for instance, can be applied based upon an availability of a specified mode of transport at an associated one of the correspondingly different way stations, a degree of energy utilization associated with an associated one of the correspondingly different way stations, a cost of routing through the correspondingly different way stations, or the number of way stations necessary to reach the destination way station. Finally, the computer program instructions select one of the associated one of the different way stations as a next destination for the shipping container that has the highest weighted score.

In even yet further illustration of the operation of the dynamic container routing module 300, FIG. 3 is a flow chart illustrating a process for intelligent dynamic package routing. Beginning in block 310, a request/response is received from a transmitting way station in a recipient way station within a route originating at an origin way station and terminating at a destination way station established for a shipping container. In decision block 320, if the request/response is a response, in block 410, a number of hops between the origin way station and the destination way station indicated in the response is incremented and transmitted to a next way station upstream towards the origin way station.

Otherwise, if the request/response is a request, in block 330, the destination and conditions of transport are extracted from the request and in decision block 340, it is determined if the recipient way station is the destination way station. If so, in decision block 350, it is determined if all of the conditions specified in the request can be met within the recipient way station. If so, in block 360 a response is transmitted to the transmitting way station indicating an acceptance of the request and including an incremented number of hops. Otherwise, in block 380 a response is transmitted to the transmitting way station indicating a rejection of the request and including an incremented number of hops.

However, in decision block 340 if the recipient way station is not the destination way station, in block 380 a cache of known capabilities of downstream way stations is inspected matching the conditions of the request to the capabilities so as to anticipate an inability of any one of the downstream way stations to meet the conditions of the request. In decision block 390, if the cached capabilities indicate an inability of a downstream one of the way stations to meet the conditions of the request, in block 370 a response is transmitted to the transmitting way station indicating a rejection of the request. Otherwise, in block 400 the request is transmitted downstream towards the destination way station to a next way station in the route.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. An intelligent dynamic container routing method, comprising:
electronically and wirelessly interrogating by a digital hub in a primary way station on a route from an origin to a final destination, a computing appliance disposed on a shipping container containing an item;
identifying from the interrogation the final destination and one or more conditions upon which the item is to be shipped to the final destination;
broadcasting a request containing an identification of the final destination and the conditions to one or more other digital hubs positioned in correspondingly different way stations and communicatively linked to the interrogating digital hub over a computer communications network;
receiving from over the computer communications network in response to the broadcast request from each of the other digital hubs, an indication of whether or not the shipping container is able to be transported to the final destination through an associated one of the correspondingly different way stations without violating any of the conditions;
selecting one of the different way stations as a next destination for the shipping container; and,
writing a record to the computing compliance of the shipping container indicating the selected one of the different way stations.

2. The method of claim 1, wherein each response from an associated one of the correspondingly different way stations includes a contemporaneous weather condition at the associated one of the correspondingly different way stations, so that the selected one of the different way stations is selected according to a corresponding response indicating a favorable weather condition.

3. The method of claim 2, wherein the favorable weather condition is a temperature condition within a specified range.

4. The method of claim 1, further comprising:
assigning a score to each of the different way stations based upon at least one criteria;
weighting each assigned score according to availability of a specified mode of transport at an associated one of the correspondingly different way stations; and,
selecting one of the associated one of the correspondingly different way stations as a next destination for the shipping container that has the highest weighted score.

5. The method of claim 1, further comprising:
assigning a score to each of the different way stations based upon at least one criteria;
weighting each assigned score according to a degree of energy utilization associated with an associated one of the correspondingly different way stations; and,
selecting one of the associated one of the correspondingly different way stations as a next destination for the shipping container that has the highest weighted score.

6. The method of claim 1, further comprising:
assigning a score to each of the different way stations based upon at least one criteria;
weighting each assigned score according to a cost of routing through an associated one of the correspondingly different way stations; and,
selecting one of the associated one of the correspondingly different way stations as a next destination for the shipping container that has the highest weighted score.

7. The method of claim 1, wherein the one or more terms are set forth in a service level agreement (SLA) for delivery of the item, the method further comprising:
assigning a score to each of the different way stations based upon at least one criteria;
comparing the assigned score of each of the way stations to at least one term in the SLA; and,
selecting one of the associated one of the correspondingly different way stations as a next destination for the shipping container that has the highest weighted score but that has an assigned score meeting the at least one term of the SLA.

8. The method of claim 7, wherein on condition that the selected one of the associated one of the correspondingly different way stations that has the highest weighted score has an assigned score that fails to meet the at least one term of the SLA, generating a prompt in a display of the primary way station to change the at least one term of the SLA so that the assigned score meets the at least one term of the SLA.

9. An intelligent dynamic container routing method, comprising:
receiving in a recipient digital hub in a corresponding way station disposed on a route from an origin to a final destination, a broadcast request from a broadcasting digital hub in a corresponding way station disposed upstream from the way station of the recipient digital hub on the route, the broadcast request encapsulating an identification of the final destination and one or more conditions upon which an item is to be shipped to the final destination;
determining whether or not the way station of the recipient digital hub is disposed at the final destination;
on condition that it is determined that the way station of the recipient digital hub is disposed at the final destination, transmitting a response to the broadcasting digital hub including an indication that the item is able to be transported to the final destination without violating any of the conditions; and,
on condition that it is determined that the way station of the recipient digital hub is not disposed at the final destination, re-broadcasting the request to a downstream way station on the route, receiving a response from the downstream way station, and transmitting the received response to the broadcasting digital hub.

10. The method of claim 9, further comprising, determining whether the way station of the recipient digital hub is able to meet the one or more conditions and on condition that the way station of the recipient digital hub is unable to meet the one or more conditions, inserting into the response before transmitting, a notification of rejection.

11. The method of claim 9, further comprising, retrieving from cached storage in the recipient digital hub, one or more capabilities of one or more way stations downstream from the way station of the recipient digital hub, determining from the capabilities in the cached storage whether the one or more way stations downstream are able to meet the one or more conditions, and on condition that the one or more way stations downstream from the way station of the recipient digital hub are unable to meet the one or more conditions, identifying from the request, a network address of a digital hub of an originating waypoint on the route, inserting into the response before transmitting, a notification of rejection and transmitting the response to the network address.

12. The method of claim 9, extracting from the response, an integer value of a number of way stations from a way station disposed at the final destination, incrementing the integer value, and inserting into the response before transmitting, the incremented integer value.

13. A computer program product for intelligent dynamic package routing, the computer program product including a computer readable storage medium having program instructions embodied therewith, the program instructions executable by a device to cause the device to perform a method including:
electronically and wirelessly interrogating by a digital hub in a primary way station on a route from an origin to a final destination, a computing appliance disposed on a shipping container containing an item;
identifying from the interrogation the final destination and one or more conditions upon which the item is to be shipped to the final destination;
broadcasting a request containing an identification of the final destination and the conditions to one or more other digital hubs positioned in correspondingly different way stations and communicatively linked to the interrogating digital hub over a computer communications network;
receiving from over the computer communications network in response to the broadcast request from each of the other digital hubs, an indication of whether or not the shipping container is able to be transported to the final destination through an associated one of the correspondingly different way stations without violating any of the conditions;
selecting one of the different way stations as a next destination for the shipping container; and,
writing a record to the computing compliance of the shipping container indicating the selected one of the different way stations.

14. The computer program product of claim 13, wherein each response from an associated one of the correspondingly different way stations includes a contemporaneous weather condition at the associated one of the correspondingly different way stations, so that the selected one of the different way stations is selected according to a corresponding response indicating a favorable weather condition.

15. The computer program product of claim 14, wherein the favorable weather condition is a temperature condition within a specified range.

16. The computer program product of claim 13, wherein the method further comprises:
assigning a score to each of the different way stations based upon at least one criteria;
weighting each assigned score according to availability of a specified mode of transport at an associated one of the correspondingly different way stations; and,
selecting one of the associated one of the correspondingly different way stations as a next destination for the shipping container that has the highest weighted score.

17. The computer program product of claim 13, wherein the method further comprises:
assigning a score to each of the different way stations based upon at least one criteria;
weighting each assigned score according to a degree of energy utilization associated with an associated one of the correspondingly different way stations; and,
selecting one of the associated one of the correspondingly different way stations as a next destination for the shipping container that has the highest weighted score.

18. The computer program product of claim 13, wherein the method further comprises:
assigning a score to each of the different way stations based upon at least one criteria;
weighting each assigned score according to a cost of routing through an associated one of the correspondingly different way stations; and,
selecting one of the associated one of the correspondingly different way stations as a next destination for the shipping container that has the highest weighted score.

19. The computer program product of claim 13, wherein the one or more terms are set forth in a service level agreement (SLA) for delivery of the item, the method further comprising:
assigning a score to each of the different way stations based upon at least one criteria;
comparing the assigned score of each of the way stations to at least one term in the SLA; and,
selecting one of the associated one of the correspondingly different way stations as a next destination for the shipping container that has the highest weighted score but that has an assigned score meeting the at least one term of the SLA.

20. The computer program product of claim 19, wherein on condition that the selected one of the associated one of the correspondingly different way stations that has the highest weighted score has an assigned score that fails to meet the at least one term of the SLA, generating a prompt in a display of the primary way station to change the at least one term of the SLA so that the assigned score meets the at least one term of the SLA.
